(19) United States
(12) Patent Application Publication
(10) Pub. No.: US 2011/0266285 A1
(43) Pub. Date: Nov. 3, 2011

(54) CARD BOARD BUCKET

(76) Inventor: Brian Santos, Valrico, FL (US)

(21) Appl. No.: 13/099,076

(22) Filed: May 2, 2011

Related U.S. Application Data
(60) Provisional application No. 61/330,379, filed on May 2, 2010.

(51) Int. Cl. B65D 5/468; B31B 1/26; B31B 7/00; B65D 25/00; B65D 5/56

(52) U.S. Cl. 220/495.06; 220/694; 220/770; 229/117.16; 229/117.27; 493/93; 493/162

(57) ABSTRACT

One embodiment of the present invention is a unique bucket. Another embodiment is a unique kit for forming a bucket. Yet another embodiment is a method for forming a bucket. Other embodiments include apparatuses, systems, devices, hardware, methods, and combinations for containers such as buckets. Further embodiments, forms, features, aspects, benefits, and advantages of the present application shall become apparent from the description and figures provided herewith.

### CROSS REFERENCE TO RELATED APPLICATIONS

The present application claims the benefit of U.S. Provisional Patent Application 61/330,379, filed May 2, 2010, and is incorporated herein by reference.

### FIELD OF THE INVENTION

The present invention relates to containers, and more particularly, to a cardboard bucket.

### BACKGROUND

Containers for fluids, such as paint, for example, remain an area of interest. Some existing systems have various shortcomings, drawbacks, and disadvantages relative to certain applications. Accordingly, there remains a need for further contributions in this area of technology.

### SUMMARY

One embodiment of the present invention is a unique bucket. Another embodiment is a unique kit for forming a bucket. Yet another embodiment is a method for forming a bucket. Other embodiments include apparatuses, systems, devices, hardware, methods, and combinations for containers such as buckets. Further embodiments, forms, features, aspects, benefits, and advantages of the present application shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 is an expanded view of a non-limiting example of a bucket in accordance with an embodiment of the present invention.

FIG. 2 depicts some aspects of a non-limiting example of a bucket in accordance with an embodiment of the present invention.

FIG. 3 depicts some aspects of a non-limiting example of an assembled bucket in accordance with an embodiment of the present invention.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

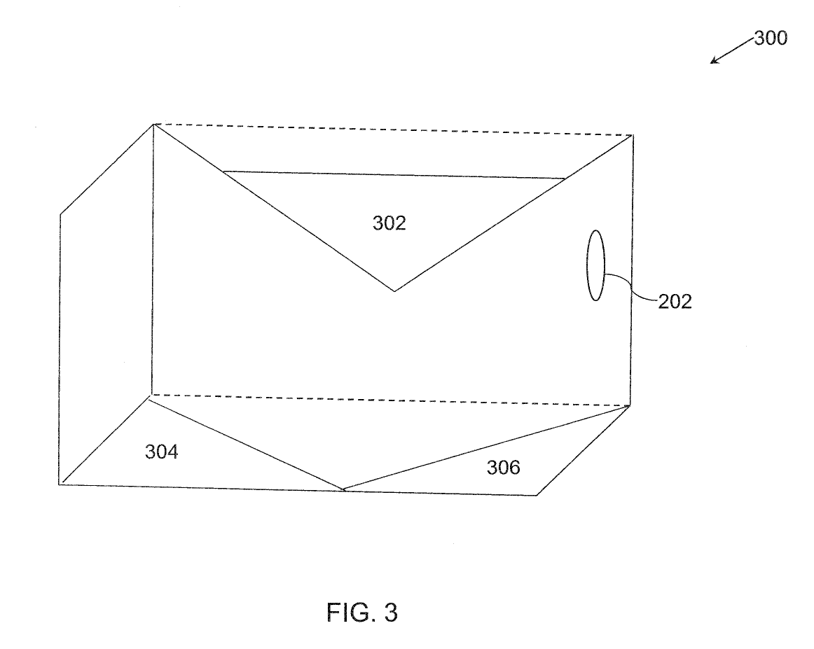

In one embodiment of the present invention, a single piece of cardboard 100 is manufactured to be folded into a cardboard bucket 300. Cardboard, as used herein, may be card stock, corrugated fiberboard, paperboard, or any other material suitable to one skilled in the art at the time of invention. The single piece of cardboard 100 may have weakened areas, such as weakened area 102, to allow for ease of folding. These weakened areas may be formed by perforating the cardboard, compressing desired locations of the cardboard, and/or partially cutting through the cardboard. The cardboard bucket 300 may be preassembled or may be sold as a kit for an end user to assemble. In one embodiment, after assembly, the cardboard bucket will contain a V-shaped trough 302. The trough 302 may or may not come to a point toward the bottom of the bucket (i.e. the trough may have a partially flat bottom). A liner capable of holding a liquid is to be inserted into trough 302. In one form, the liner may be bag like. The liner may also be a flat sheet of plastic or any other lining device known to one of ordinary skill in the art at the time of invention capable of allowing trough 302 to contain a liquid or semi-solid such as paint, thinner, stain, drywall mud, concrete, or the like. The liner may be designed to be removable after each use or may be permanently affixed to the cardboard bucket 300. Hollow sections 304 and 306 of cardboard will provide support for the V-shaped trough 302 on either side of the trough as shown in FIG. 3. The hollow sections 304 and 306 may incorporate handles 202 for ease of moving the cardboard bucket 300. The hollow sections 304 and 306 may interlock below the V-shaped trough 302, forming a bottom 204.

In another embodiment of the cardboard bucket, rather than using a single piece of cardboard 100 with weakened areas, multiple pieces of cardboard which may or may not contain weakened areas are interlocked to form a cardboard bucket. A V-shape may be formed using a single piece of cardboard having a single weakened area. The sides of the V-shape may be separate pieces of cardboard which are then affixed to the V-shape forming a trough. The support structure from the trough may be constructed from separate pieces of cardboard, some of which may contain weakened areas to allow ease of folding, which the V-shaped trough is then placed in and affixed to. A liner capable of holding a liquid lines the V-shaped trough.

In yet another embodiment of the present invention, one piece of cardboard can be mechanically stamped, folded, and assembled into a V-shaped trough and a support structure for the V-shaped trough. This mechanical process eliminates the need for an end user to assemble the invention and therefore eliminates the need for weakened areas to be inserted into the cardboard. A liner for the V-shaped trough may be inserted prior to purchase by an end user or the end user may insert the liner.

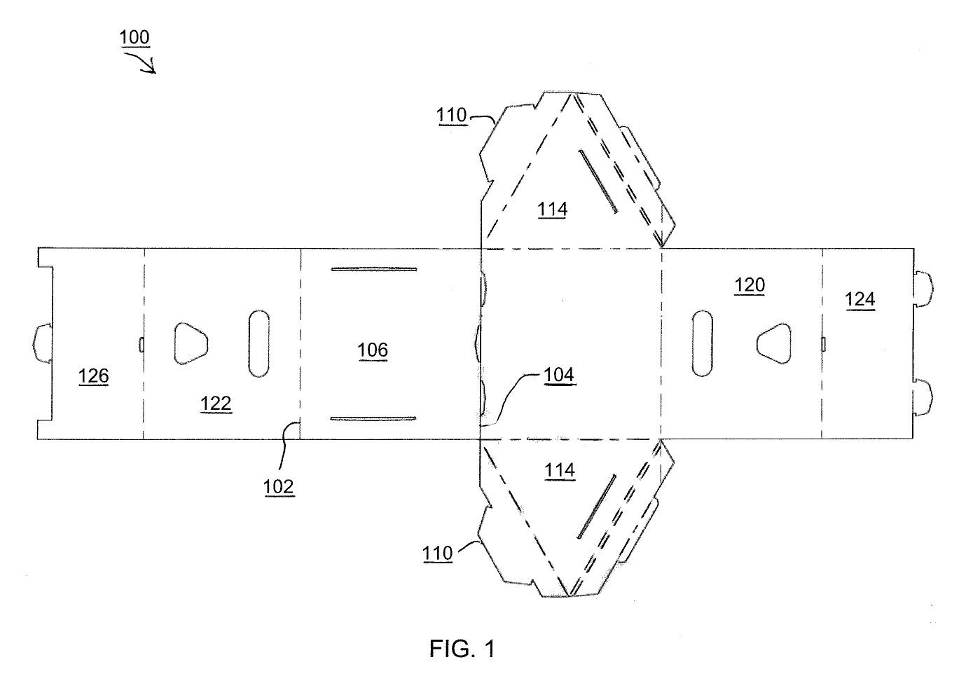

In a further embodiment of the present invention, a cardboard structure is folded to form a bucket capable of containing a liquid. A fold is placed between portions 106 and 108 of a main cardboard body 100, along a weakened area 104, to form a V-shape. Two wing pieces 114 extending from a main body of the cardboard 100 are folded along weakened areas 112. Wing pieces 114 are folded from one side of the V-shape to be affixed to the other side of the V-shape forming a trough as shown by the arrows in FIG. 1. FIG. 1 depicts tabs 110 being utilized to form a solid V-shaped trough. Locking fastners, snap-type fastners, or tabs may be utilized to affix the wing pieces 114 to form the V-shape. Portions 120, 122, 124, and 126 of the body structure 100 on either side of the V-shaped trough are then folded along weakened areas to form a support structure for the trough. On either side of the V-shaped trough, portions 120 and 122 are folded away from the trough opening. The portions 120 and 122 when folded away from the trough opening will act as two vertically supporting sides for the trough. Portions 124 and 126 are then interconnected to form a base structure. The point of the V-shaped trough may extend to touch the base or may be suspended above the base. The V-shaped trough is then lined with a material capable of holding a liquid.

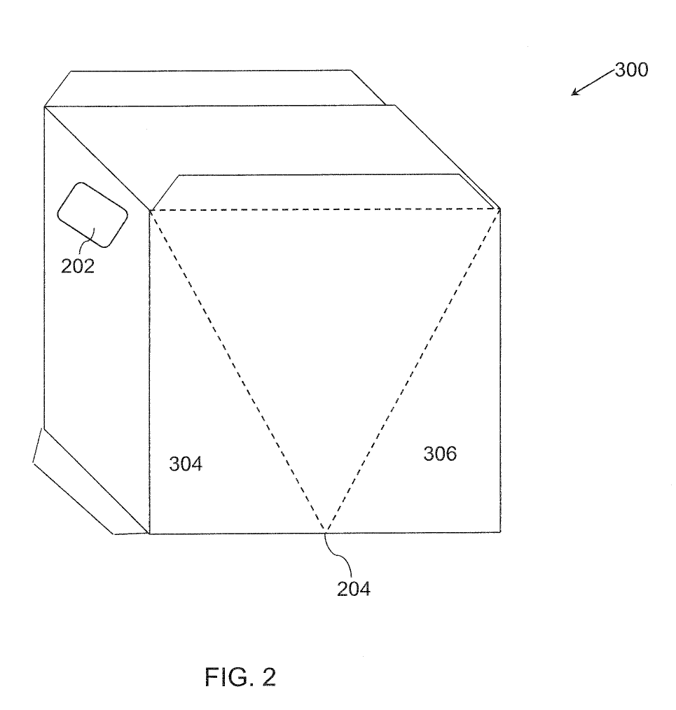

Various alternate embodiments are also contemplated in the present invention. The two supporting sides may have carrying handles as shown in FIGS. 2 and 3. The supporting sides may be constructed in any manner suitable to provide support adequate to keep the V-shaped trough upright during use. The base can be a solid piece of cardboard or may be multiple pieces of cardboard which are interconnected. The supporting sides may themselves act as a base. A thermoformed painters grate may be included as part of the cardboard bucket. The grate may also be a common injection molded plastic grate. The grate may hang from a side of the cardboard bucket into the V-shaped trough.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A bucket comprising:
a trough having a substantially V-shape;
a waterproof liner covering the trough to form a fluid tight volume;
a first portion supporting a first wall of the trough;
a second portion supporting a second wall of the trough; and
wherein the trough, the first portion, and the second portion are all defined as portions of a single piece of material.

2. The bucket of claim 1, wherein a painter's grate hangs into the trough.

3. The bucket of claim 1, wherein a thermoformed painters grate hangs into the trough.

4. The bucket of claim 1, wherein the single piece of material includes weakened areas configured to allow for ease of folding.

5. The bucket of claim 1, wherein the first portion and the second portion contain handles.

6. The bucket of claim 1, wherein the first portion and the second portion interlock forming a solid base.

7. The bucket of claims 1-6, wherein the first and second portions are hollow.

8. The bucket of claims 1-7, wherein the single piece of material is cardboard.

9. The bucket of claims 1-7, wherein the single piece of material is selected from card stock, corrugated fiberboard, or paperboard.

10. A kit for forming a bucket comprising:
a single piece of cardboard containing a plurality of weakened areas wherein the weakened areas provide for the formation of a V-shaped trough that defines a fluid tight volume when assembled.

11. A method for forming a bucket comprising:
folding along a weakened area of cardboard to form a V-shape;
folding along weakened areas of cardboard to provide sides for the V-shape;
affixing the sides to the V-shape thereby forming a V-shaped trough;
folding a first support for the V-shaped trough;
folding a second support for the V-shaped trough; and
affixing the first support to the second support under the V-shaped trough thereby forming a unitary base for the V-shaped trough and supports.

12. A method for forming a bucket comprising:
placing a fold between a first portion of a structure and a second portion;
folding two wing pieces interconnected to the structure toward one of the first portion and the second portion and affixing them thereto forming a V-shaped trough;
folding a third portion of the structure away from the V-shaped trough;
folding a fourth portion of the structure away from the V-shaped trough structure;
interconnecting a fifth portion of the structure and a sixth portion of the structure to form a base, wherein the third and fourth portions in combination with the base support the V-shaped trough; and
inserting a liner into the V-shaped trough.

13. A bucket comprising:
a first trough wall;
a second trough wall foldably interconnected to the first trough wall, wherein the first and second trough walls are approximately rectangular;
a first triangular side foldably interconnected to at least one of the first trough wall and the second trough wall;
a second triangular side foldably interconnected to at least one of the first trough wall and the second trough wall, wherein the first triangular side and the second triangular side are structured to interconnect the first trough wall and the second trough wall, forming a V-shaped trough;
means for supporting the V-shaped trough; and
a liner inserted into the V-shaped trough.
